(19) United States
(12) Patent Application Publication
(10) Pub. No.: US 2008/0043587 A1
(43) Pub. Date: Feb. 21, 2008

(54) Method for Buffering Data Streams Read from a Storage Medium

(76) Inventors: Dirk Gandolph, Ronnenberg (DE); Harald Schiller, Hannover (DE); Jobst Horentrup, Hannover (DE); Ralf Ostermann, Hannover (DE); Hartmut Peters, Barsinghausen (DE)

Correspondence Address: THOMSON LICENSING LLC, Two Independence Way, Suite 200, PRINCETON, NJ, 08540, US

(21) Appl. No.: 10/551,575

(22) PCT Filed: Mar. 22, 2004
(86) PCT No.: PCT/EP04/02998

§ 371 Date: Oct. 2, 2006

(30) Foreign Application Priority Data
Apr. 2, 2003 (EP) 03007593.1

(51) Int. Cl. G11B 20/10

(52) U.S. Cl. 369/47.15

(57) ABSTRACT

A method for optimizing a scheduler for an optical pick-up reduces switch times required for seamless video angle switching. The pick-up reads data streams from different files on an optical storage medium, e.g. Blu-Ray disc. Seamless video angle switching requires reading and buffering a new video data stream from another file, delaying the switch to be visible. Labels that mark entry points for seamless angle switching are attached to the video stream, and are stored together with the video data in a buffer. When an angle switch is requested, and thus a switch to a new video data stream, the scheduler determines the time before data from the new data stream can be buffered, detects the next label, and stores the new data beyond the label, thus flushing non-relevant parts of the previous buffer contents.

### FIELD OF THE INVENTION

This invention relates to a method for operating a scheduler for an optical pick-up. The pick-up reads data streams from an optical storage medium, wherein the data streams belong to different data types like audio, video, subtitles or other data, and are distributed to several files on the storage medium.

### BACKGROUND

Pre-recorded or self-recorded optical discs may support “Out Of Multiplex” (OOM) formats. Out of multiplex is a format that stores different streaming components, e.g. video, audio and subtitles, on different locations on the disc, i.e. different files. This is possible with various standardized media, e.g. Blu-ray disc or DVD. Also, a video technique known as multi-angle may be implemented. Multi-angle means that a video film may contain for certain scenes various alternative view angles, all running at a parallel time axis, which are selectable by the user and may be integrated seamlessly into the video. To playback an OOM source, the pick-up has to read all required streams from the different locations, before the playback device decodes the streams by their specific decoders for synchronous representation. That means that the pick-up has to jump from stream to stream in order to serve all decoders simultaneously, without noticeable interruption of the presentation. Usually, a pick-up contains an actuator carrying an optical sensor, and the pick-up is movable by a mechanical drive for raw adjustment, while the actuator is separately movable for fine adjustment without a mechanical drive.

The straight forward solution for providing OOM technology with optical drives is buffer technique: additional stream buffers serve to bridge the times that are needed for jumping to the other requested streams and reading them. A typical example comprises three streams: video, audio and subtitles. E.g. the video buffer is dimensioned such that jumping to the audio stream, loading of the audio buffer, jumping to the subtitle stream, loading of the subtitle buffer and jumping back to the video stream can be executed without the video buffer running empty. The other buffers, e.g. for audio and subtitles, are dimensioned analogously.

### SUMMARY OF THE INVENTION

One problem arising from the fact that multiple files must be read simultaneously is the high pick-up jump frequency causing noise and wastage. A further problem is the delay appearing during seamless video angle switches. The delay is the time needed from requesting the video angle change until seeing the other video angle. It is determined mainly by the video buffer size, or by the amount of time until the video buffer has run empty and the new content reaches the video decoder. The same applies to the start up of OOM decoding. The time passing by from pressing the start button until effectively starting the display is quite long, since all buffers must be filled from scratch.

The problem to be solved by the invention is to provide a method for reducing delay times required for stream switching, e.g. video angle switch. This problem is solved by the method disclosed in claim 1. For a HDTV stream, being a typical application of blu-ray disc, the buffers are quite large. The large buffers cause a long delay for the user waiting for a requested angle change to get visible, which delay can be reduced by the inventive method. The same problem arises for the start-up of OOM decoding, and can be improved by the method disclosed in claim 6.

An apparatus utilizing the method is disclosed in claim 3.

The minimization of switching delay time for seamless video angle switches is reached by the introduction of angle switch labels within the video buffer. The angle switch labels are used to determine those parts of the video buffer which are obsolete in case of an angle switch, and can be removed, or overwritten, without the risk of a buffer under run. When the obsolete content has been removed from the video buffer, the buffer may be filled with the requested new content instead. Overwriting the obsolete data performs both steps simultaneously. This controlled replacement of obsolete content from the video buffer reduces the video angle switch time, because the decoder needs not to process the obsolete content.

Advantageously, the invention can also be used to optimize the partitioning of a given amount of buffering space for the described application.

Advantageous embodiments of the invention are disclosed in the dependent claims, the following description and the figures.

### BRIEF DESCRIPTION OF THE DRAWINGS

Exemplary embodiments of the invention are described with reference to the accompanying drawings, which show in

FIG. 1 a) a bit stream buffer for bridging the jump and load times of three OOM streams, being dimensioned conventionally;

FIG. 1 b) a bit stream buffer for bridging the jump and load times of three OOM streams, containing additional extension buffer space according to the invention;

FIG. 2 a qualitative example for the resulting pick-up jump frequency, comparing equally shared extension buffers fₛₖᵢₚ and asymmetrically shared extension buffers f*ₛₖᵢₚ;

FIG. 3 a state-of-the-art video buffer model during video angle switch;

FIG. 4 a) a video buffer model according to the invention, before a video angle switch; and

FIG. 4 b) a video buffer model according to the invention, after a video angle switch.

### DETAILED DESCRIPTION OF THE INVENTION

In the following, a detailed description of the invention including a detailed analysis of the problem is given.

OOM decoding is mainly influenced by the following mutually dependent parameters:
the pick-up maximum channel bit rate R,
the pick-up access time T_{acc},
the pick-up jump frequency fⱼᵤₘₚ,
the resulting total buffer size B_{Σ},
the number of separate streams N,
and the individual stream bit rate rᵢ.

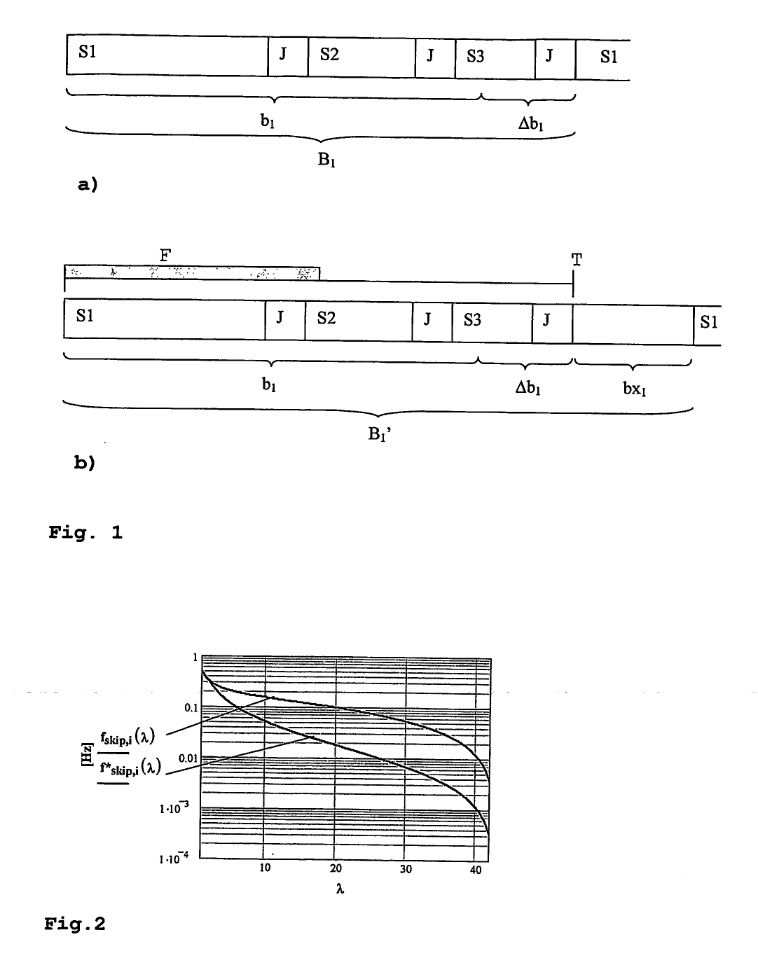

The general approach for OOM decoding is to buffer all jump and loading times requested to serve all N streams decoded. FIG. 1 a) shows an example for three streams. The base buffer b₁, e.g. for video, is enlarged by the bridge buffer Δb₁, which is dimensioned in such a way that the following operations can be executed while the video buffer is being read, but without the video buffer running empty: jumping J to the audio stream, loading S2 the audio buffer, jumping J to the subtitle stream, loading S3 the subtitle buffer and jumping J back to video stream. S1 is the time required to load the complete video buffer b₁, Δb₁, itself. The base buffers of audio and subtitle are enlarged in the same way by Δb₂ and Δb₃.

The buffer sizes can be calculated to:

Bᵢ=bᵢ+Δbᵢ (eq.1.0) Buffer size per stream

B=Σ bᵢ (eq.1.1) Total base buffer size

ΔB=Σ Δbᵢ (eq.1.2) Total extension buffer size

B_{Σ}=B+ΔB=Σbᵢ+Σ Δbᵢ (eq.1.3) Total buffer size

The buffer filling time for a single stream buffer is determined by the equation:

$${T}_{fill ; i} = \frac{{B}_{i}}{( R - {r}_{i} )} \qquad ( eq . 2 )$$

When accumulating all jump and filling times for three bit streams, a linear equation system (LES) can be set up, and the resulting bridge buffers Δbᵢ can be determined. The resulting LES for N streams can be written in matrix form as:

$$( \begin{matrix}Δ {b}_{1} \\ Δ {b}_{2} \\ ⋮ \\ ⋮ \\ Δ {b}_{N}\end{matrix} ) = {( \begin{matrix}\frac{1}{{r}_{1}} & \frac{1}{{r}_{2} - R} & ⋯ & ⋯ & \frac{1}{{r}_{N} - R} \\ \frac{1}{{r}_{1} - R} & \frac{1}{{r}_{2}} & & & \frac{1}{{r}_{N} - R} \\ ⋮ & & ⋰ & & ⋮ \\ ⋮ & & & ⋰ & ⋮ \\ \frac{1}{{r}_{1} - R} & \frac{1}{{r}_{2} - R} & & & \frac{1}{{r}_{N}}\end{matrix} )}^{- 1} \cdot ( \begin{matrix}N \cdot {T}_{acc} - {\sum }_{i \neq 1}^{N} \frac{{b}_{i}}{{r}_{i} - R} \\ N \cdot {T}_{acc} - {\sum }_{i \neq 2}^{N} \frac{{b}_{i}}{{r}_{i} - R} \\ ⋮ \\ ⋮ \\ N \cdot {T}_{acc} - {\sum }_{i \neq N}^{N} \frac{{b}_{i}}{{r}_{i} - R}\end{matrix} ) \qquad ( eq . 3 )$$

To supply N OOM streams, the resulting pick-up jump frequency can be estimated to:

$${f}_{jump} \approx \frac{N}{{\sum }_{i = 1}^{N} ( {T}_{acc} + {T}_{fill , i} )} = \frac{1}{{T}_{acc} + \frac{1}{N} {\sum }_{i = 1}^{N} \frac{{B}_{i}}{( R - {r}_{i} )}} \qquad ( eq . 4 )$$

Since the rᵢ are variable bit rates (VBR), eq.4 is an estimation for an average value. Further, the effective jump frequency may be higher because the different buffers will not always run completely empty, i.e. the effective Bᵢ are smaller.

Eq.3 and eq.4 describe a simple round-robin scheduler: after having filled a buffer completely, the scheduler switches to the next buffer. This continues until all stream buffers have been served, and the scheduler starts a new loop through all the streams. To avoid worst-case buffer underflow when having high read data rates, the round-robin scheduling is done independently from the individual buffer fullness. This means a constant pick-up jump frequency, being higher than actually necessary.

According to the invention, the pick-up jump frequency can be reduced when the bridging stream buffers are further enlarged and another than the round-robin scheduler model is used. This other scheduler model, according to the invention, could be a free running scheduler as described by the following:
every OOM stream has its own buffer,
every OOM buffer is filled upon request, when reaching a threshold, e.g. “nearly empty”,
a queuing mechanism is used to handle concurrent requests, i.e. each request for filling an OOM buffer is queued once.

For the free running scheduler according to the invention, the resulting pick-up jump frequency is determined by accumulating the individual pick-up jump frequencies and is calculated by:

$${f}_{jump} = {\sum }_{i = 1}^{N} {f}_{i} \qquad ( eq . 5 )$$

FIG. 1 b) shows a scheme of a further enlarged stream buffer. The buffer b₁,Δb₁ is extended by an extension buffer bx₁. While the extension buffer is being read, the pick-up is not used. This effects a reduction of the individual streams pick-up jump frequency, and thus influences the resulting pick-up jump frequency according to eq.5. Using an extension buffer changes eq.1.0, which is now

Bᵢ=bᵢ+Δbᵢ+bxᵢ (eq. 6)

But the buffer extension bxᵢ has two drawbacks, the first being that it requires more memory, and the second being that it influences the necessary bridge buffer Δb₂,Δb₃ for the other stream buffers, due to the additional fill time required for bx₁. Enlarging the other bridge buffers Δb₂,Δb₃ by adding extension buffers bx₂,bx₃ ensures an in time response of the free running scheduler for any stream buffer fill request. The best compromise for the size of the bridge buffers, according to the invention, is outlined in the following.

First the individual streams pick-up jump frequencies fᵢ are determined. After the free running scheduler has filled the stream buffer Δbᵢ+bᵢ+bxᵢ completely, the buffer keeps being read and runs empty. When reaching a threshold T, e.g. Δbᵢ+bᵢ, the buffer may send a refill request to the scheduler, and the scheduler queues the request. The stream buffer is further being emptied, until the scheduler serves the request. It is assumed for this example that typically half of the remaining buffer (Δbᵢ+bᵢ)/2 runs empty before the scheduler acts. The remaining buffer filling, at the time when the request is served, is shown in FIG. 1 b) by the gray area F. The following calculation applies for the individual streams pick-up jump frequency:

$$\begin{matrix}{f}_{i} = {( {T}_{fill , i} + {T}_{empty , i} + {T}_{acc} )}^{- 1} & ( eq . 7.1 ) \\ {f}_{i} = {( \frac{\frac{{b}_{i} + Δ {b}_{i}}{2} + {bx}_{i}}{R - {r}_{i}} + \frac{\frac{{b}_{i} + Δ {b}_{i}}{2} + {bx}_{i}}{{r}_{i}} + {T}_{acc} )}^{- 1} & ( eq . 7.2 ) \\ {f}_{i} = \frac{2 \cdot {r}_{i} \cdot ( R - {r}_{i} )}{{b}_{i} \cdot R + Δ {b}_{i} R + 2 \cdot {bx}_{i} \cdot R + 2 \cdot {T}_{acc} \cdot {r}_{i} \cdot R - 2 \cdot {T}_{acc} \cdot {r}_{i}^{2}} & ( eq . 7.3 )\end{matrix}$$

T_{empty,i} is the time in which the buffer for stream i is being read, without being filled. Enlarging the extension buffers bxᵢ as described by eq.5 and eq.7 can reduce the resulting pick-up jump frequency.

According to the invention it is particularly advantageous to enlarge the extension buffers bxᵢ asymmetrically, i.e. select each extension buffer bxᵢ individually, such that the highest pick-up jump frequency f_{i,r=max} is a multiple of the resulting individual pick-up jump frequencies f_{i,r≠max}. This is expressed by the following equations:

f_{l,r=max}=λ·f₁=λ·f₂= . . . =λ·f_{n,n≠f} . . . =λ·f_{N} (eq. 8.1)

f_{Video=λ·f}_{Audio}=λ·f_{Subtitle} (eq. 8.2)

In eq.8.1, f₁ is a function of bx₁ etc., and λ is the asymmetry factor. When the relations of eq.8.1 are chosen in such a way that the stream with the highest bit rate, typically the video stream, has the highest jump frequency f_{i,r=max}, then this leads to a reduction of the resulting pick-up jump frequency, while using the same total amount of extension buffer B_{Σ} as previous scheduling systems. This optimizes the usage of extra buffer, and therefore saves the most bytes for extra buffer. The stream buffers for the lower bit rate streams are individually enlarged to meet the asymmetry factor λ.

Eq.8.2 is an example for a typical blu-ray disc application for OOM decoding of multimedia content, including e.g. HD video, audio and subtitle. When the three streams for video, audio and subtitle are read, and the buffers of the lower rated streams are enlarged according to the invention, then the video buffer can be filled λ times before the audio and subtitle buffers need to be refilled. By this enlargement of buffer sizes for the audio and subtitle streams, the time between pick-up jumps can be longer, and thus the individual streams pick-up jump frequency lower. The λ times filling of the video buffer in the meantime does not increase the pick-up jump frequency, as it requires only actuator movements of the pick-up, no jumps. Thus the result is a lowered pick-up jump frequency.

The improved resulting jump frequency can be calculated to:

$$\begin{matrix}{f}_{jump}^{*} \leq {f}_{jump} = {\sum }_{i = 1}^{N} {f}_{i} & ( eq . 9.1 ) \\ {f}_{jump}^{*} = min ( \frac{N - 1}{λ} ; 1 ) \cdot {f}_{r = max} + ( \frac{N - 1}{λ} ) \cdot {f}_{r = max} & ( eq . 9.2 )\end{matrix}$$

In a typical application example, fᵣ₌ₘₐₓ corresponds to the video stream buffer. By combining eq.3 and eq.8.2 for three streams, a new LES can be constructed, containing further the values for the extension buffers bx₂,bx₃ of audio and subtitle. The LES is

(Δb₁ Δb₂ Δb₃ bx₂ bx₃)=M⁻¹(λ)×v(λ) (eq. 10.1)

$$\begin{matrix}M ( λ ) = ( \begin{matrix}1 & \frac{- {r}_{1}}{R - {r}_{2}} & \frac{- {r}_{1}}{R - {r}_{3}} & \frac{- {r}_{1}}{R - {r}_{2}} & \frac{- {r}_{1}}{R - {r}_{3}} \\ \frac{- {r}_{2}}{R - {r}_{1}} & 1 & \frac{- {r}_{2}}{R - {r}_{3}} & 0 & \frac{- {r}_{2}}{R - {r}_{3}} \\ \frac{- {r}_{3}}{R - {r}_{1}} & \frac{- {r}_{3}}{R - {r}_{2}} & 1 & \frac{- {r}_{3}}{R - {r}_{2}} & 0 \\ 0 & \frac{R}{{r}_{2} \cdot ( R - {r}_{2} )} & \frac{- R}{{r}_{3} \cdot ( R - {r}_{3} )} & \frac{2 \cdot R}{{r}_{2} \cdot ( R - {r}_{2} )} & \frac{- 2 \cdot R}{{r}_{3} \cdot ( R - {r}_{3} )} \\ \frac{R}{{r}_{1} \cdot ( R - {r}_{1} )} & 0 & \frac{- R}{λ \cdot {r}_{3} \cdot ( R - {r}_{3} )} & 0 & \frac{- 2 \cdot R}{λ \cdot {r}_{3} \cdot ( R - {r}_{3} )}\end{matrix} ) & ( eq . 10.2 ) \\ v ( λ ) = ( \begin{matrix}{r}_{1} \cdot 3 \cdot {T}_{acc} + \frac{{r}_{1} \cdot {b}_{2}}{R - {r}_{2}} + \frac{{r}_{1} \cdot {b}_{3}}{R - {r}_{3}} \\ {r}_{2} \cdot 3 \cdot {T}_{acc} + \frac{{r}_{2} \cdot {b}_{1}}{R - {b}_{1}} + \frac{{r}_{2} \cdot {b}_{3}}{R - {r}_{2}} \\ {r}_{3} \cdot 3 \cdot {T}_{acc} + \frac{{r}_{3} \cdot {b}_{1}}{R - {r}_{1}} + \frac{{r}_{3} \cdot {b}_{2}}{R - {r}_{2}} \\ \frac{- R \cdot {b}_{2}}{{r}_{2} \cdot ( R - {r}_{2} )} + \frac{R \cdot {b}_{3}}{{r}_{3} \cdot ( R - {r}_{3} )} \\ 2 \cdot {T}_{acc} \cdot ( \frac{1}{λ} - 1 ) - \frac{R \cdot {b}_{1}}{{r}_{1} \cdot ( R - {r}_{1} )} + \frac{R \cdot {b}_{3}}{λ \cdot {r}_{3} \cdot ( R - {r}_{3} )}\end{matrix} ) & ( eq . 10.3 )\end{matrix}$$

Both the matrix M(λ) and the disturbing v(λ) are functions of the asymmetry λ. But λ cannot be chosen arbitrarily. Since it modifies the time that is required to fill the other buffers, it is limited by the condition

$${T}_{empty , i} - 3 \cdot {T}_{acc} - {\sum }_{n = 1 , n \neq i}^{N} {T}_{fill , n} \geq 0 \qquad ( eq . 11 )$$

This means that the time that can be bridged by a buffer T_{empty,i} without refilling must be equal or higher than the time that is required to access the other streams, read them and store them to their respective buffers. Using the LES eq.10, and considering the conditions of eq.11, the bridge buffers Δbᵢ and the extension buffers bxᵢ can be determined.

The gain reached by the asymmetry λ for a typical application, like a movie from blu-ray disc, is depicted in FIG. 2. It shows the resulting pick-up jump frequency f_{skip,i} of a scheduling system that uses equally shared extension buffers, as compared to the resulting pick-up jump frequency f*_{skip,i} of a system according to the invention that uses asymmetric extension buffers, both being functions of the variable λ. For all shown reasonable values of λ, i.e. λ being 2 or more, the pick-up jump frequency for the inventive scheduler is lower than for the conventional scheduler. The diagram is based on typical values for parameters, i.e. T_{acc}=0.8 s, R=54 Mbps, r_{Video}=40 Mbps, r_{Audio}=640 kbps, r_{Subtitle}=2kbps.

Another gist of the invention is the reduction of switching delay time for seamless video angle switches. For OOM decoding a seamless video angle switch can be compared to a change of the video stream file. This must be done seamlessly for the user, i.e. without any picture artifacts, blanking or pausing in video. Seamless video angle switches are possible only at specific byte positions in the stream. Those positions are indicated by navigation information related to the stream, e.g. group-of-picture (GOP) boundaries for the case of MPEG.

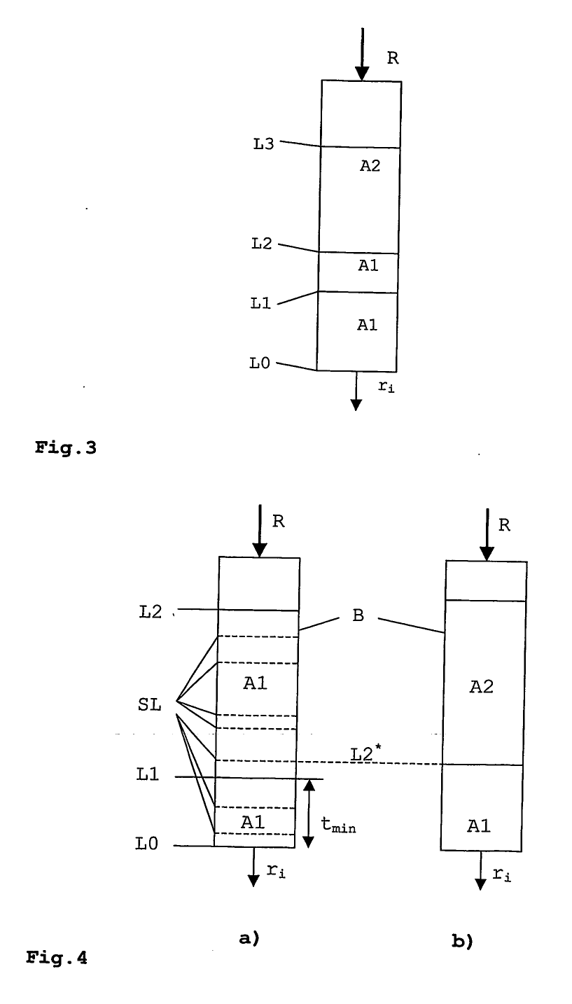

FIG. 3 shows a conventional video stream buffer, being filled with the pick-up bit rate R and simultaneously being emptied with the decoding bit rate rᵢ. On average, the filling rate R must be larger or equal than the decoding bit rate rᵢ, to prevent the buffer from running empty. When reproducing a video, a stream related to a first view angle A1 is loaded into the buffer and reproduced. After a certain time of reproduction, the user requests a video angle change. The buffer has at this time a remaining fill level L1. When the scheduler has received this request and the video buffer is to be refilled again, the pick-up will not immediately jump to the other video stream related to the second view angle A2. Instead, the pick-up continues reading further bytes of the first view angle A1, until a seamless connection is detected in the bit stream; at this time the buffer has a new fill level L2, containing a video stream related to the first view angle A1. After reaching the seamless connection, the pick-up may switch the video input stream by jumping to the video stream related to the second view angle A2. Then this stream is loaded into the video buffer, on top of level L2.

In the meantime the decoder is reading data from the video bit buffer at the read position L0, and thus reduces the filling of the buffer, i.e. the levels L1 and L2 are continuously moving down. The effective delay time before switching the video angle is in this scenario determined by the buffer fullness L1 when the video angle change request reaches the scheduler, the length of the new loaded sequence related to the old video angle A1 till a seamless connection is reached, filling the buffer up to L2, and the video decoding bit rate rᵢ. The effective delay time for the user is determined by the amount of buffer fullness L2-L0 and the video bit rate, as described by

$${T}_{delay} = \frac{{B}_{L 2 - L 0}}{{r}_{i}} \qquad ( eq . 12 )$$

To reach a small delay, it is useful to keep the video bit buffer small. This, however, increases the pick-up jump frequency, as described above. Also, the delay time may vary noticeably because the buffer fullness L1 at the time of a request is not determined. An improvement of video angle switching, and advantageously for every channel switching, can be reached by the proposed invention.

Minimizing the buffer size B_{L2-L0} lowers the effective delay time T_{delay}. According to the invention, this is reached by the introduction of angle switch labels within the video buffer. Angle switch labels mark possible seamless connection points located within the bit stream. When a scheduler according to the invention fills the video bit buffer, it evaluates the possible seamless connection entry points, given by the related navigation information, and marks the corresponding bit buffer locations with a label. This may be implemented in various ways, e.g. by adding the label to the buffer contents. While the video bit stream is read for decoding, the labels are logically moving down, always being associated to the same seamless connection. In practice, however, a ring buffer or a FIFO may be used, which effectively does not move any bytes in the buffer, and thus the physical position, or address, of the labels remains the same. Therefore it is also possible to store the label as the address of a seamless connection position, e.g. in a separate buffer, and locate the seamless connection entry point by comparing the address representing the label with the data read address, checking for a minimum distance.

Advantageously, the angle switch labels can be used to easily determine those parts of the video buffer which are obsolete in case of an angle change being requested, and which can be removed without the risk of a buffer under run. According to the invention, the stream switch algorithm described in the following can be employed.

FIG. 4 a) shows an exemplary video buffer, being filled with the pick-up bit rate R and being read with the decoder bit rate rᵢ. When a user requests a video angle change from the current angle A1 to another angle A2, the scheduler evaluates the angle switch labels SL it has currently stored. At the time when the request is processed, the buffer is filled up to a current filling level L2, and may contain various angle switch labels SL. Moving the pick-up to the position where the new video bit stream can be read takes a worst-case minimum time tₘᵢₙ after receiving the request. During this time tₘᵢₙ on the video buffer is constantly being read, and may not run empty since the angle switch should be seamless. The buffer space that is required for the amount of data that will be read during that time tₘᵢₙ calculates generally according to the following relation:

buffer=rᵢ·time (eq. 13)

Since rᵢ is usually variable, due to VBR, the highest possible rate can be used to cope with the worst case. According to the invention, the buffer size calculated by eq.13 is added to the current buffer read position L0 to calculate the earliest possible switch position L1. Further, the first angle switch label L2* found above this position L1 is the earliest possible angle switch position. This specific angle switch label L2* is called “bonding label” herein. When the scheduler starts the next video buffer filling process, it may load the new video content of the requested angle A2, starting from the bonding label L2*. Thus, a part of the old buffer content relating to angle A1, namely from the bonding label L2* to the current buffer filling level L2, is deleted, and substituted by the new content relating to angle A2. This situation is shown in FIG. 4 b). The effective delay time for the user is determined by the remaining amount of data relating to the old angle A1 and the video bit rate, and calculates to:

$${T}_{delay}^{*} = \frac{{B}_{L 2 * - L 0}}{{r}_{i}} \qquad ( eq . 14 )$$

### Since B_{L2*-L0} in eq.14 is less than B_{L2-L0} in eq.12, and rᵢ is the same in both equations, the delay time T*_{delay} is reduced.

Which of the switch labels can be used as bonding label depends on the minimal possible switching time tₘᵢₙ. When assuming that the pick-up starts immediately upon reception of the request, this is the time between the pick-up starting to move to the new video stream and the new video data being buffered. It comprises the pick-up access time T_{acc} mentioned before and intermediate processing times, which are very small compared to T_{acc}. Therefore the delay time before actually switching the video angle, as described in eq.14, can be further reduced by reducing the minimal possible switching time tₘᵢₙ. According to the invention this can be achieved by modifying the free running scheduler model, as described in the following. When the inventive scheduler receives an angle switch request, it may analyze which stream buffer fill requests are registered in the queue. Depending on the queued fill requests, it may determine the minimum time tₘᵢₙ and select the optimal bonding label.

If the buffer contains no switch label, the pick-up may continue to read the old data stream until a switch label is detected, and then switch to the new data stream.

Advantageously, the described mechanism for seamless switching is not restricted to video angle switching, but can be used for any kind of video data switching or user-manipulated reproduction of video data, e.g. if a video scene may be replaced by another video scene. Further, it can be used not only for video data streams, but also for other data streams. Especially, the same mechanism may be used for audio data streams, e.g. to adopt audio reproduction in case of a video angle switch. Moreover, it is possible that various types of switch labels exist, referring only to specific data streams and containing a corresponding indication. In this case the inventive method can be applied analogously. E.g. in a multi-story environment it is possible that a label refers to a plurality of possible data streams. One of them may be selected, using any mechanism, then read and buffered. The label contains e.g. an identifier, and the possible data streams to continue are marked with the same identifier.

In a further embodiment of the invention, the processing of requests may be modified even if they are already in the queue when an angle switch request occurs. The scheduler may execute all requests that are in the queue, but stop their execution prematurely, i.e. before the stream buffer is completely filled. This saves more time and decreases the video angle switching delay time. The interrupted stream buffer fill process must however obey to

$${T}_{fill , min} = {\sum }_{i = 1}^{in queue} ( {T}_{acc} + \frac{{b}_{i} + Δ {b}_{i}}{{r}_{i}} ) \qquad ( eq . 15 )$$

### Eq.15 means that at least the base buffer bi and the bridge buffer Δbᵢ must have been be filled before the stream buffer fill request is prematurely interrupted.

Another advantage of the scheduler according to the invention is a special strategy to start the complete OOM decoding of N streams. The normal delay at start-up results from the accumulation of N pick-up jumps and N stream buffer filling times. By using eq.2 and eq.6, the start-up delay time is

$${T}_{startup} = {\sum }_{i = 1}^{N} ( {T}_{acc} + \frac{{b}_{i} + Δ {b}_{i} + {bx}_{i}}{R} ) \qquad ( eq . 16 )$$

### The denominator is larger than in eq.2 because the decoding is not running yet, and therefore the buffers are filled quicker.

The optimization of the start-up procedure according to the invention consists of two improvements that are independent from each other, and that are described in the following.

The first improvement concerns the amount of buffer to fill during start-up. When the free running scheduler receives a start up command, it is not loading the OOM stream buffers completely. Similar to the angle switch algorithm described above it fills only a part of the OOM stream buffers, and the bit stream with the highest bit rate is served last. Taking the application example above, the scheduler at start-up fills the OOM stream buffers for the audio or subtitle first, and then fills the OOM video stream buffer. Further, it needs to load only the base buffer bᵢ and the bridge buffer Δbᵢ for all but the last OOM stream. Also the OOM stream buffer refill requests are set for all but the last OOM stream buffer. Then the last stream buffer may be loaded completely, but decoding for all streams may already start when only the base buffer portion bᵢ of the last OOM stream buffer has been filled. Thus start-up delay is

$${T}_{startup}^{*} = N \cdot {T}_{acc} + \frac{{b}_{i = {r}_{i , max}}}{R} + {\sum }_{i = 1 , i \neq {r}_{i , max}}^{N - 1} \frac{{b}_{i} + Δ {b}_{i}}{R} \qquad ( eq . 17 )$$

### After this start-up procedure the free running scheduler may work normally as described before, and all queued buffer fill requests may be bridged by the bridge buffers Δbᵢ.

The second improvement for a start-up procedure according to the invention concerns the sequence of the OOM stream buffers, i.e. the order in which all but the last OOM stream buffer are loaded. A dominant part of eq.17 is the pick-up access time T_{acc} that is a physical parameter, namely in the worst case the time required for a full stroke jump, and thus cannot be reduced. According to the invention, the first product of eq.17 can be reduced, since the first addend “N·T_{acc}” is a worst-case value. It can be minimized in the following way.

When the disc is initially read, the reading device determines which files are contained, and their physical location on the disc. Therefore the scheduler may have this information, and select the OOM stream buffer filling order dependant from the physical location of the OOM stream files on the disc. The scheduler may start with the OOM stream buffer at the most outer or most inner physical disc location, depending on which is nearer to the current pick-up position. After that the scheduler loads the physically nearest OOM stream in its respective OOM stream buffer. This is repeated until only the last stream is left, being the one with the highest bit rate. The OOM stream with the highest bit rate is loaded last, independent from its physical location on the disc.

Advantageously, the pick-up will not move more than twice across the full disc when using this start-up procedure. This corresponds to two full stroke jumps. The resulting start-up delay is

$${T}_{startup}^{**} = 2 \cdot {T}_{acc} + \frac{{b}_{i = {r}_{i , max}}}{R} + {\sum }_{i = 1 , i \neq {r}_{1 , max}}^{N - 1} \frac{{b}_{i} + Δ {b}_{i}}{R} \qquad ( eq . 18 )$$

### Eq.18 shows that the dominating addend “N·T_{acc}” from eq.17 is decreased for N>2 and becomes independent from the number of streams treated, thus reducing start-up time.

The invention is also applicable in systems where not all streams require buffering. E.g. there could be another data stream included on the medium, containing data that are not repetitively or not periodically read, e.g. only once at the beginning of a presentation, and that can be processed at the pick-up data rate, and therefore require no buffering.

Further, multiple video streams may be available for angle change, and the buffered labels may contain a mark defining possible video streams they refer to. Thus a hierarchy may be achieved, e.g. each of the alternative view angles may contain alternative zoom levels, zoom targets, color settings or the like. Also different time raster for different view angles may thus be implemented.

Moreover, the disclosed method may also be used for inserting e.g. an additional video stream at a defined position of the presentation, like multi-story technique, even if the presentation data are already stored in the buffer. The additional video stream may also come from another source than the optical storage medium, e.g. the internet.

The inventive method can be employed e.g. by all types of media reproduction devices that are capable of switching seamlessly between different data sources of same data type, especially Blu-ray disc players.

Advantageously, the method disclosed herein can also be used to optimize the partitioning of a given amount of buffering space for the described application.

1. A method for buffering data streams of same data type, wherein
a first read data stream contains labels marking entry points for seamlessly switching to data from another stream of same data type;
the first read data stream including the labels is buffered in a buffer;
a request for seamlessly switching to a second data stream of same data type is received, the second data stream being contained in a different file than the first data stream;
an entry point for seamless switching to the second data stream is determined within the buffered first data stream by selecting the first label that is buffered after a minimum amount of buffered data, the minimum amount being the maximum amount of data that may be read out of the buffer during a specified time, wherein the specified time is the time between receiving said request and buffering the second data stream; and
the second data stream is read and buffered in at least logically the same buffer, the buffering starting from said first label.

2. Method according to claim 1, wherein pointers containing the buffer address of the buffered entry points are buffered separately, and are used for determining said first label.

3. Apparatus for buffering data streams of same data type, wherein the data streams are contained in different files and a data stream may contain labels marking entry points for seamlessly switching to data from another stream, the apparatus comprising:
means for receiving data streams or reading data streams from a storage medium;
first buffer for buffering a first data stream, including the contained labels;
means for receiving a request for seamlessly switching to a second data stream of same data type as the first data stream;
means for determining within the buffered first data stream an entry point for seamless switching to the second data stream, wherein the entry point is determined by selecting the first label that is buffered after a minimum amount of buffered data, the minimum amount being the maximum amount of data that may be read out of the buffer during a specified time, wherein the specified time is the time between receiving said request and buffering the second data stream; and
means for buffering the second data stream in the first buffer, wherein the buffering starts from said first label.

4. Apparatus according to claim 3, further comprising a separate buffer for buffering pointers, the pointers indicating positions in the first buffer where the entry points are buffered and being used for determining said first label.

5. Method or apparatus according to claim 1, wherein said data type is video, audio or subtitle data.

6. Method or apparatus according to claim 5, wherein said buffered data may be read, without interruptions and without buffer underrun, after an initial filling procedure, the initial filling procedure comprising filling the audio and subtitle buffers partly before filling the video buffer completely.

7. Method or apparatus according to claim 1, wherein the first and the second data stream are read from the same storage medium.

8. Method or apparatus according to claim 7, wherein the storage medium is a removable optical disc.

9. Method or apparatus according to claim 1, wherein the data stream is an MPEG video stream, and an entry point is a group-of-pictures boundary.

10. Method or apparatus according to claim 1, wherein the method or apparatus is used for video angle switching.

11. Method or apparatus according to claim 1, wherein a label may refer to a plurality of specific second data streams of same data type, wherein an arbitrary method is used to determine the second data stream to be read or received.
